(19) United States
(12) Patent Application Publication
(10) Pub. No.: US 2010/0074102 A1
(43) Pub. Date: Mar. 25, 2010

(54) TRANSMISSION DEVICE AND TRANSMISSION METHOD

(75) Inventors: Ryoichi MUTOH, Kawasaki (JP); Yuji Tochio, Kawasaki (JP); Shinya Kano, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/493,030

(22) Filed: Jun. 26, 2009

(30) Foreign Application Priority Data
Sep. 19, 2008 (JP) 2008-241711

(51) Int. Cl. H04L 12/26

(52) U.S. Cl. 370/225

(57) ABSTRACT

A transmission device includes an ingress edge device that receives a frame, an egress edge device having a plurality of destination addresses, and a rewrite unit that rewrites a destination MAC address of the frame to another destination MAC address of the egress edge device when detecting a failure on a working path between the ingress edge device and the egress edge device.

### CROSS-REFERENCE TO RELATED APPLICATION

This application is based upon and claims the benefit of priority of the prior Japanese Patent Application No. 2008-241711, filed on Sep. 19, 2008, the entire contents of which are incorporated herein by reference.

### FIELD

A certain aspect of embodiments relates to a transmission device and a transmission method.

### BACKGROUND

There is a method of relating a plurality of VLAN tags named as Q-in-Q specified with IEEE 802.1 ad, as a technology of providing broad area Ethernet (registered trademark) service. IEEE 802.1 ah PBB (Provider Backbone Bridge), IEEE 802.1 Qay PBB-TE (Provider Backbone Bridge—Traffic Engineering) and so on are being standardized as a more scalable technology. Japanese Patent Application Publication No. 2006-520572 discloses a protection technology to protect a signal from a failure such as disconnection in a network.

### SUMMARY

According to an aspect of the present invention, there is provided a transmission device including an ingress edge device that receives a frame, an egress edge device having a plurality of destination addresses, and a rewrite unit that rewrites a destination MAC address of the frame to another destination MAC address of the egress edge device when detecting a failure on a working path between the ingress edge device and the egress edge device.

According to another aspect of the present invention, there is provided a transmission method including receiving a frame at an ingress edge device, rewriting a destination MAC address of the frame to another destination MAC address of an egress edge device when a failure on a working path between the ingress edge device and the egress edge device is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a schematic view of a network to which a transmission device in accordance with a first embodiment is adapted;

FIG. 2 illustrates a frame format of PBB;

FIG. 3 illustrates a schematic view of a structure of a transmission device and a preset value of each forwarding device;

FIG. 4 illustrates an operation in a case where there exists a failure between forwarding devices;

FIG. 5 illustrates an example of a flowchart executed by a forwarding device;

FIG. 6 illustrates a schematic vide of an ingress edge device in accordance with a second embodiment; and

FIG. 7 illustrates an example of a flowchart executed by an ingress edge device.

### DESCRIPTION OF EMBODIMENTS

1:1 path protection of PBB-TE is being considered in standardization of IEEE 802.1 Qay. However, there is a problem of requiring time from a failure occurrence to a protection switching, because a path is switched at an entrance of the path. It is necessary to transmit a frame to a protection path at all times, although a failure time may be reduced because of an egress switching in a case of 1+1 path protection. Therefore, use efficiency of a band may be degraded.

An overhead may be enlarged if a segment protection is realized with a B-tunnel technology of encapsulating a PBB-TE frame with a MAC-in-MAC method. Here, “MAC” means “Media Access Control”.

The following is a description of embodiments of the present invention, with reference to the accompanying drawings. The following embodiments provide a transmission device and a transmission method realizing efficient protection.

### [a] First Embodiment

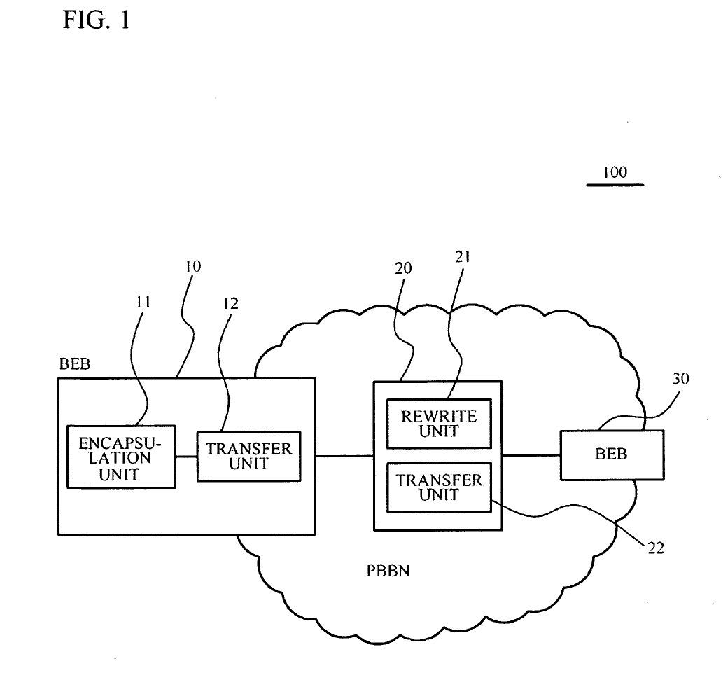

FIG. 1 illustrates a schematic view of a PBB-TE network 100 to which a transmission device in accordance with a first embodiment is adapted. In the embodiment, the network 100 has a PBB (Provider Backbone Bridge) structure, and is a backbone network (PBBN: Provider Backbone Bridged Network) housing and coupling IEEE 802.1 ad PBN (Provider Bridged Network). The PBB encapsulates a user Ethernet (registered trademark) frame in a MAC-in-MAC method and forwards the frame. PBB-TE is an extended PBB so that a path of traffic may be controlled.

As illustrated in FIG. 1, the network 100 includes an ingress edge device (BEB: Backbone Edge Bridge) 10, a plurality of forwarding devices (BCB: Backbone Core Bridge) 20, and an egress edge device 30. The edge device 10 includes an encapsulation unit 11 and a transfer unit 12. Each of the forwarding devices 20 includes a rewrite unit 21 and a transfer unit 22.

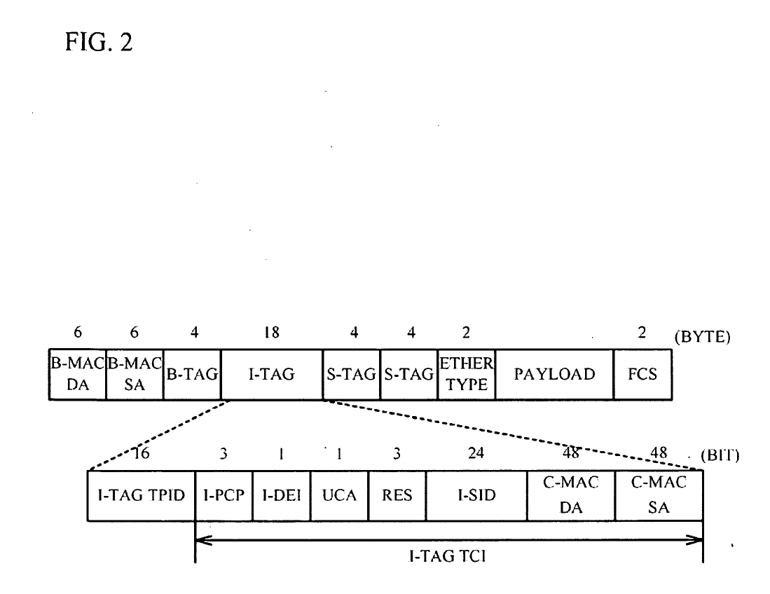

FIG. 2 illustrates a frame format of the PBB-TE. As illustrated in FIG. 2, user data is encapsulated with an I-TAG (Backbone Service Instance tag), a B-TAG (Backbone VLAN TAG), a B-DA (Backbone Destination MAC Address), and a B-SA (Backbone Source MAC Address).

The B-SA is an ingress edge device toward a PBBN. The B-SA is expressed with a MAC address of an encapsulating edge device. The B-TAG has the same format as a Service VLAN TAG specified with IEEE 802.1 ad. The B-TAG includes a B-TAG TPID and a B-TAG TCI (Tag Control Information). The B-TAG TCI includes 12 bits of Backbone VLAN ID (B-VID).

The I-TAG includes a destination MAC address (C-DA), a source MAC address (C-SA), and an I-SID of a user identifier (Backbone Service Instance Identifier) of a user frame. The TPID (Tag Protocol Identifier) indicates a tag type.

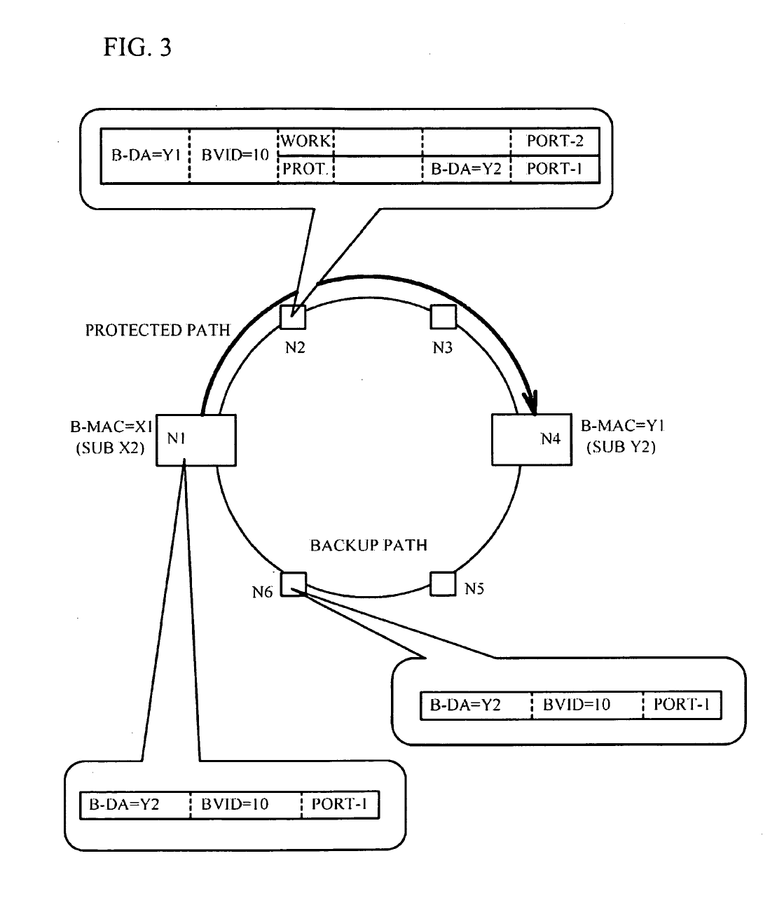

FIG. 3 illustrates a schematic view of a structure of the transmission device and a preset value of each forwarding device, in a case where a ring network is structured with a PBB-TE device. In FIG. 3, the ingress edge device 10 is illustrated with a numeral N1, and the egress edge device 30 is illustrated with a numeral N4. In FIG. 3, there are a path that starts from the ingress edge device N1, passes through the forwarding devices N2 and N3, an gets to the egress edge device 30 and a path that starts from the ingress edge device N1, passes through the forwarding devices N6 and N5, and gets to the egress edge device 30. The transmission device includes the edge devices N1 and N4 and the forwarding devices N2, N3, N5 and N6.

A main address and a sub address of the MAC address (B-MAC) of the edge device N1 are expressed as X1 and X2 respectively. Similarly, a main address and a sub address of the B-MAC of the edge device N4 are expressed as Y1 and Y2 respectively. In FIG. 3, two types of ESP (Ethernet (registered trademark) Switched Path) are prepared. One of the ESPs is used as a working path (Protected Path). The other is used as an protection path (Backup Path). The B-VIDs used for the two paths are 10 respectively.

A table illustrated in FIG. 3 is a FDB (Filtering Database) for a frame forwarding. Further, there is a table for encapsulating a user frame at a forwarding device. The table for encapsulating the user frame stores an entry of the working path at the edge device N1. In FIG. 3, an entry for forwarding of the protection path is illustrated.

The FDB of the forwarding device N2 holds information of the working path and the protection path with respect to a single <B-DA, B-VID> entry. The same holds for the forwarding devices N3. The forwarding device N6 holds only the entry of the protection path, because the forwarding device N6 is not on the working path. The same holds for the forwarding devices N5.

A description will be given of an operation at normal condition. The edge device N1 receives a user frame from a device out of the ring. The encapsulation unit 11 of the edge device N1 relates I-SID to the user frame as a user identifier. The encapsulation unit 11 relates a source address [X1] to the B-SA, and relates a destination address [Y1] of the user frame to the B-DA. Further, the encapsulation unit 11 relates B-VID=10 to the user frame. The transfer unit 12 transmits a frame encapsulated by the encapsulation unit 11 to the forwarding device N2.

The forwarding devices N2 and N3 receive a frame from a port 1 respectively. The forwarding devices N2 and N3 may have a function of reversing a received frame if a source address of the received frame is its own address. In the embodiment, the forwarding devices N2 and N3 do not reverse the frame, because B-SA=X1. The forwarding devices N2 and N3 search the FDB with B-VID+B-DA of the received frame and determine a transmission port. The forwarding devices N2 and N3 transmit the frame from a port 2.

The egress edge device N4 reverses a received frame if the B-SA address of the received frame is its own address. In the embodiment, the edge device N4 does not reverse the received frame because B-SA=X1. The edge device N4 terminates the frame, removes the B-TAG, the B-DA/SA and the I-TAG, and generates a user frame, because the B-DA=Y1 of the received frame is its own address.

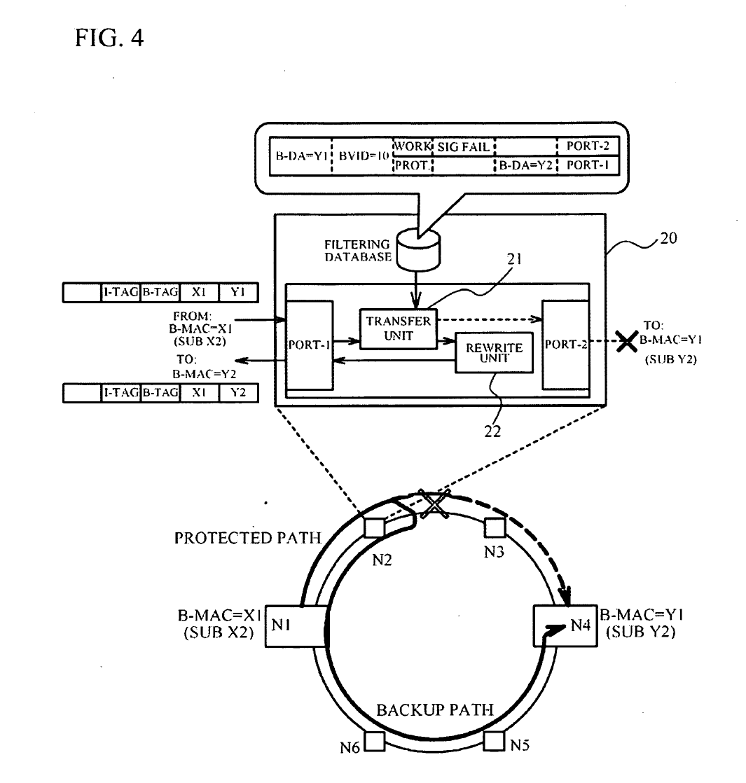

Next, a description will be given of an operation in a case where there exists a failure between the forwarding device N2 and the forwarding device N3, with reference to FIG. 4. The ingress edge device N1 receives a user frame from a device out of the ring. The encapsulation unit 11 of the edge device N1 relates I-SID to the user frame as a user identifier. The encapsulation unit 11 relates a source address [X1] to the B-SA, and relates a destination address [Y1] of the user frame to the B-DA. Further, the encapsulation unit 11 relates B-VID=10 to the user frame. The transfer unit 12 transmits a frame encapsulated by the encapsulation unit 11 to the forwarding device N2.

The forwarding device N2 receives a frame from a port 1. The forwarding device N2 searches the FDB with B-VID+B-DA of the received frame and determines a transmission port. The forwarding device N2 transfers the frame toward a protection side, because a link to the forwarding device N3 being a transmission port is down (signal transmission is failed at the work). In this case, the rewrite unit 21 rewrites B-DA of the entry to Y2, and transmits the frame from a port 1.

The edge device N1 is set so as to reverse a received frame if B-SA of the received frame is its own address. The B-SA of the received frame is the address [X1] in order to reverse a loop frame. However, the edge device N1 does not reverse the frame when the rewrite unit 21 rewrites the B-DA. Here, a sub address may be recorded in the edge device 10 in advance as a method of judging whether the B-SA is a sub address. The MAC address of a specific range may be defined as a sub address. The transfer unit 12 searches the FDB with B-VID (10)+B-DA (Y2) of the received frame, and determines a transmission port. In this case, the transfer unit 12 transmits a frame to the forwarding unit N6.

The forwarding devices N6 and N5 receive a frame with a port 1. The forwarding devices N6 and N5 search the FDB with B-VID (10)+B-DA (Y2) of the received frame, and determine a transmission port. In this case, the forwarding devices N6 and N5 transmit a frame from a port 2. The egress edge device N4 terminates the frame, removes B-TAG, B-DA/SA and I-TAG, and generates a user frame, because B-DA=Y2 of the received frame is its own address.

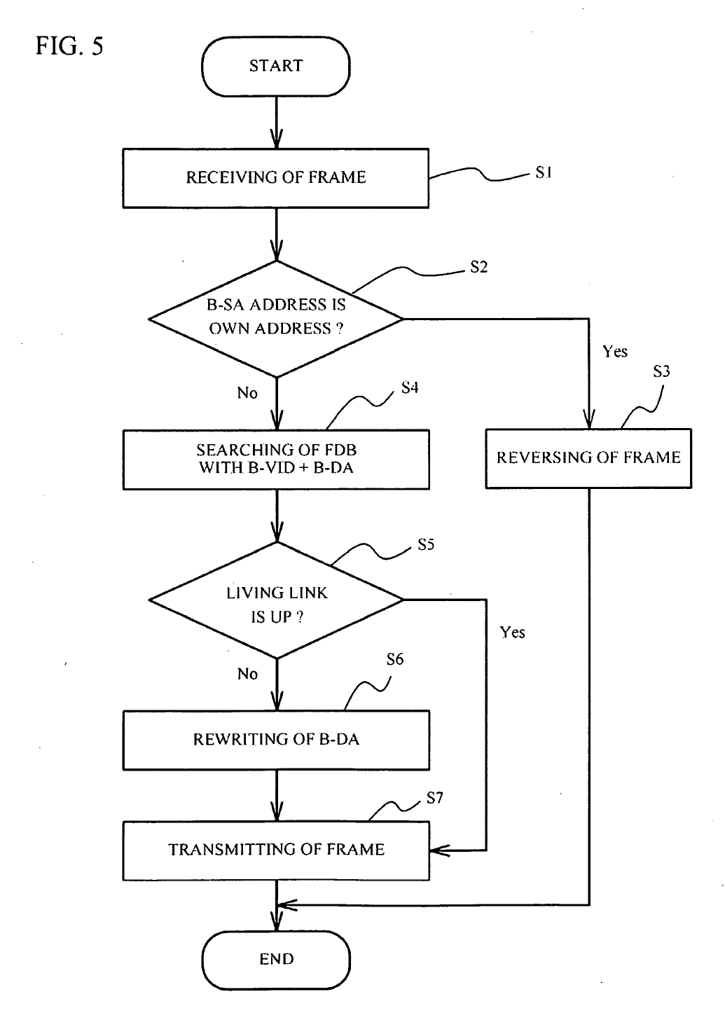

FIG. 5 illustrates an example of a flowchart executed by the forwarding device N2. As illustrated in FIG. 5, the forwarding device N2 receives a frame (Step S1). Next, the forwarding device N2 determines whether B-SA address is its own address (Step S2). If it is determined that the B-SA address is its own address in Step S2, the forwarding device N2 reverses the frame (Step S3), and terminates the execution of the flowchart.

If it is not determined that the B-SA address is its own address in Step S2, the forwarding device N2 searches the FDB with B-VID+B-DA (Step S4). Next, the forwarding device N2 determines whether the working link is up (Step S5). If it is not determined that the working link is up in Step S5, the forwarding device N2 rewrites B-DA to a sub address (Step S6). Then, the forwarding device N2 transmits the frame (Step S7), and terminates the execution of the flowchart. If it is determined that the working link is up in Step S5, the forwarding device N2 executes Step S7.

With the transmission device in accordance with the embodiment, it is possible to provide a segment protection to an Ethernet (registered trademark) ring network of PBB-TE. In this case, it is possible to reduce an overhead compared to a B-tunnel method. And it is possible to reduce a delay and a band, because a reversed backup path does not get to a failure point on an opposite side, being different from a general segment protection. It is therefore possible to provide an efficient protection.

The B-SA may be rewritten at the failure point. In this case, a B-SA element is added to the entry of the FDB of the egress edge device N4 in the case of FIG. 3. The ingress edge device N1 receives a user frame from a device out of the ring. The encapsulation unit 11 relates I-SID to the user frame as a user identifier. The encapsulation unit 11 relates a source address [X1] of the user frame to the B-SA, and relates a destination address [Y1] of the user frame to the B-DA. Further, the encapsulation unit 11 relates B-VID=10 to the user frame. The transfer unit 12 transmits a frame encapsulated by the encapsulation unit 11 to the forwarding device N2.

The forwarding device N2 receives a frame with a port 1. The forwarding device N2 searches the FDB with B-VID+B-DA of the received frame and determines a transmission port. The forwarding device N2 transfers the frame toward a protection side, because a link to the forwarding device N3 being a transmission port is down. In this case, the rewrite unit 21 rewrites B-DA of the entry to Y2, rewrites B-SA of the entry to X2, and transmits the frame from a port 1.

The edge device N1 does not reverse the frame, because the B-SA of the received frame is its own sub address [X2]. The transfer unit 12 looks up the FDB with B-VID (10)+B-DA (Y2) of the received frame, and determines a transmission port. In this case, the transfer unit 12 transmits the frame to the forwarding unit N6.

The forwarding devices N6 and N5 receive a frame with a port 1. The forwarding devices N6 and N5 look up the FDB with B-VID (10)+B-DA (Y2) of the received frame, and determine a transmission port. In this case, the forwarding devices N6 and N5 transmit a frame from a port 2. The egress edge device N4 terminates the frame, removes B-TAG, B-DA/SA and I-TAG, and generates a user frame, because B-DA=Y2 of the received frame is its own address.

The source MAC address may be rewritten in the above-mentioned method. In this case, it is also possible to provide a segment protection to an Ethernet (registered trademark) ring network of PBB-TE. It is possible to reduce an overhead compared to a B-tunnel method. And it is possible to reduce a delay and a bandwidth, because a reversed backup path does not get to a failure point on an opposite side, being different from a general segment protection.

### [b] Second Embodiment

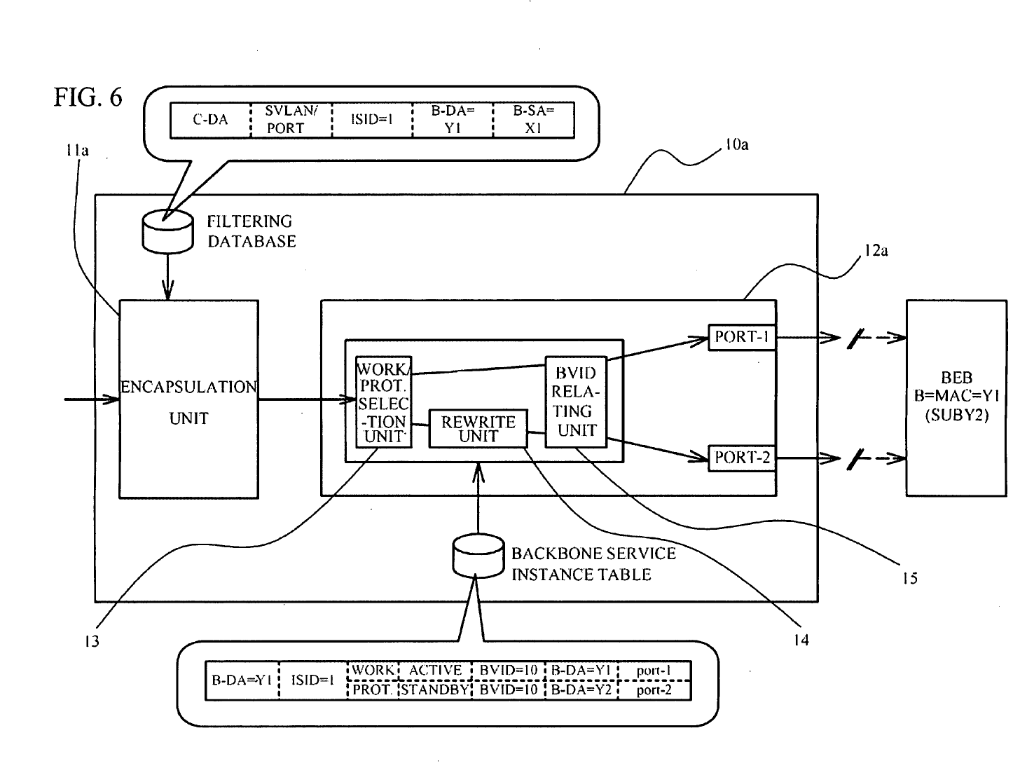

FIG. 6 illustrates a schematic view of an ingress edge device 10a in accordance with a second embodiment. The edge device 10a is an edge device for providing a path protection. As illustrated in FIG. 6, the edge device 10a includes an encapsulation unit 11a and a transfer unit 12a. The transfer unit 12a includes a Work/Prot. selection unit 13, a rewrite unit 14, and a BVID relating unit 15.

The edge device 10a receives a user frame from a device of an external network. The encapsulation unit 11a relates I-SID to the user frame as a user identifier. The encapsulation unit 11a relates its own address [X1] to B-SA, and relates a destination address [Y1] of the user frame to B-DA. Further, the encapsulation unit 11a relates B-VID=10 to the user frame. The encapsulation unit 11a transmits a frame encapsulated by the encapsulation unit 11a to the transfer unit 12a.

The transfer unit 12a receives a frame from the encapsulation unit 11a, and determines B-VID and a transmission port with the I-SID (+B-DA). In this case, the Work/Prot. selection unit 13 sets an output port 2 to a port 2 if the Work is Inactive. In this case, the rewrite unit 14 rewrites B-DA=Y1 to B-DA=Y2. The BVID relating unit 15 relates B-VID to the frame and transmits the frame to the port 2.

A path of B-VID=10 and B-DA=Y2 is set in advance in another forwarding device. Each of the forwarding devices searches the FDB with B-VID+B-DA of the received frame, determines a transmission port, and transmits the frame.

An egress edge device confirms that B-SA is not Y1 or B-SA is not Y2, in order to prevent a looping. The egress edge device terminates the frame, removes B-TAG, B-DA/SA and I-TAG, and generates a user frame, because B-DA=Y2 of the received frame is its own address.

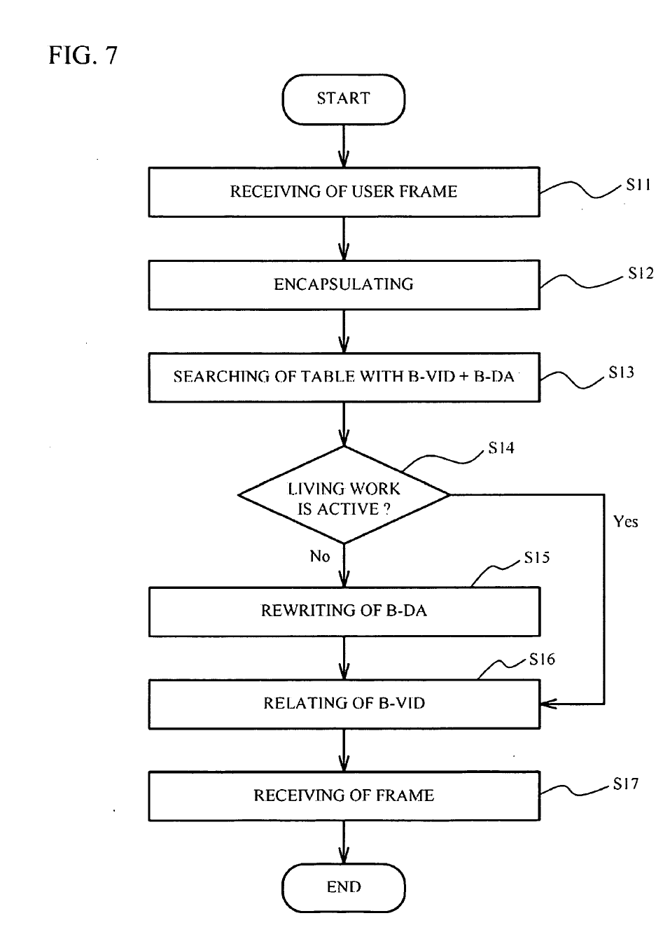

FIG. 7 illustrates an example of a flowchart executed by the ingress edge device 10a. As illustrated in FIG. 7, the edge device 10a receives a frame (Step S11). Next, the encapsulation unit 11a encapsulates the frame (Step S12). Then, the encapsulation unit 11a looks up a table with B-VID+B-DA (Step S13).

Next, the Work/Prot. selection unit 13 determines whether the Work is active (Step S14). If it is not determined that the Work is active in Step S14, the rewrite unit 14 rewrites B-DA to a sub address (Step S15). Next, the BVID relating unit 15 relates B-VID to the frame (Step S16), and transmits the frame (Step S17). After that, the flowchart is terminated. If it is determined that the Work is active in Step S14, the BVID relating unit 15 executes Step S16.

It is possible to reduce a B-VID label space by using not 12 bits B-VID but 48 bits MAC address, in the above-mentioned path protection. It is therefore possible to provide an efficient protection.

The ingress edge device 10 may be set not to reverse a frame when VLAN-ID is rewritten to a predetermined value by the rewrite unit, even if the source MAC address is its own address, in the above-mentioned embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A transmission device comprising:
an ingress edge device that receives a frame;
an egress edge device having a plurality of destination addresses;
a rewrite unit that rewrites a destination MAC address of the frame to another destination MAC address of the egress edge device when detecting a failure on a living path between the ingress edge device and the egress edge device.

2. The transmission device as claimed in claim 1, wherein the ingress edge device reverses a frame received thereby when a source MAC address of the frame is its own address, and does not reverse the frame when the rewrite unit rewrites the destination MAC address of the frame even if the source MAC address is its own address.

3. The transmission device as claimed in claim 1, wherein:
the ingress edge device has a plurality of source MAC addresses; and
the rewrite unit rewrites a source MAC address of the frame to another address of the ingress edge device when detecting the failure.

4. The transmission device as claimed in claim 3, wherein the ingress edge device does not reverse the frame when the rewrite unit rewrites the source MAC address of the frame.

5. The transmission device as claimed in claim 1, wherein the rewrite unit rewrites header information of the frame when detecting the failure.

6. The transmission device as claimed in claim 5, wherein the header information is VLAN-ID.

7. The transmission device as claimed in claim 6, wherein the ingress edge device reverses a frame received thereby when a source MAC address of the frame is its own address, and does not reverse the frame when the VLAN-ID is rewritten to a given value even if the source MAC address is its own address.

8. A transmission method comprising;
receiving a frame at an ingress edge device;
rewriting a destination MAC address of the frame to another destination MAC address of an egress edge device when a failure on a working path between the ingress edge device and the egress edge device is detected.

9. The transmission method as claimed in claim 8, wherein a frame received by the ingress edge device is reversed when a source MAC address of the frame is an address of the ingress edge device, and is not reversed when the destination MAC address of the frame is rewritten in the rewriting of the destination MAC address even if the source MAC address is the address of the ingress edge device.

10. The transmission method as claimed in claim 8, wherein a source MAC address of the frame is rewritten to another address of the ingress edge device when the failure is detected in the rewriting of the destination MAC address.

11. The transmission method as claimed in claim 10, wherein the frame received by the ingress edge device is not reversed if the source MAC address of the frame is rewritten in the rewriting of the destination MAC address.

12. The transmission method as claimed in claim 8, wherein header information of the frame is rewritten if the failure is detected in the rewriting of the destination MAC address.

13. The transmission method as claimed in claim 12, wherein the header information is VLAN-ID.

14. The transmission method as claimed in claim 13, wherein a frame received by the ingress edge device is reversed when a source MAC address of the frame is an address of the ingress edge device, and is not reversed when the VLAN-ID is rewritten to a given value even if the source MAC address is the address of the ingress edge device.
